(19) United States
(12) Patent Application Publication
(10) Pub. No.: US 2022/0189670 A1
(43) Pub. Date: Jun. 16, 2022

(54) MAGNETIC BODY FOR AN INDUCTOR AND A METHOD OF MANUFACTURING MAGNETIC MATERIAL FOR AN INDUCTOR INCLUDING SAME

(71) Applicants: HYUNDAI MOTOR COMPANY, Seoul (KR); KIA CORPORATION, Seoul (KR); CHANG SUNG CO., Cheongju-si (KR)

(72) Inventors: Young Min Kim, Siheung-si (KR); Tae Kyung Lee, Incheon (KR); Nam Kyu Choi, Incheon (KR)

(73) Assignees: HYUNDAI MOTOR COMPANY, Seoul (KR); KIA CORPORATION, Seoul (KR); CHANG SUNG CO., Cheongju-si (KR)

(21) Appl. No.: 17/463,208

(22) Filed: Aug. 31, 2021

(30) Foreign Application Priority Data
Dec. 15, 2020 (KR) 10-2020-0175884

(51) Int. Cl. H01F 1/147; H01F 41/02; H01F 27/255

(52) U.S. Cl. CPC H01F 1/147; H01F 27/255; H01F 41/0246

(57) ABSTRACT

A magnetic body for an inductor has an excellent direct-current bias property in a high-current region. The magnetic body for the inductor is a magnetic body used in an inductor for high current. The magnetic body has a core particle including a Fe—Al-based alloy containing 10 wt % or more of Al and a balance of Fe and other inevitable impurities, and has an insulating layer including Al₂O₃ formed on the surface of the core particle. A method of manufacturing such a magnetic material for the inductor is also disclosed.

### CROSS REFERENCE TO RELATED APPLICATION

The present application claims priority to Korean Patent Application No. 10-2020-0175884, filed Dec. 15, 2020, the entire content of which is incorporated herein for all purposes by this reference.

### BACKGROUND

### 1. Field of the Disclosure

The present disclosure relates to a magnetic body for an inductor and a method of manufacturing a magnetic material for an inductor including the same. More particularly, the present disclosure relates to a magnetic body for an inductor, which has an excellent direct-current bias property in a high-current region, and to a method of manufacturing a magnetic material for an inductor including the same.

### 2. Description of the Related Art

In a vehicle using an electric charging method, an OBC (on-board charger), which is a charging device for performing charging using a high voltage battery, is required.

The OBC serves to convert a commercial alternating-current (AC) power source (such as 220 V) into direct current (DC). In this case, the phases of the voltage and current are different from each other and thus a power factor deteriorates, resulting in reduced power conversion efficiency.

Therefore, in order to prevent the power conversion efficiency from being reduced, the power factor is set close to 1 by rectifying the commercial power source of the alternating current (AC) with PFC (power factor correction) in the OBC so as to correct the phase deviation of the voltage and the current.

In the inductor used in such a PFC circuit, a material having a small inductance value drop and a low loss (core loss) value in a high-current region (DC bias) is useful. Accordingly, in general, a permalloy (e.g. an alloy of 50% iron (Fe) and 50% nickel (Ni) content) material is used.

As mentioned earlier, in an inductor material for high current, it is important to maintain inductance (direct-current bias property) in a high-current region. To this end, a molded body of an alloy powder having a low magnetic permeability (60μ or less) is used.

In general, in order to reduce the magnetic permeability of a soft magnetic alloy powder, a method of adding an insulating material such as phosphoric acid or a ceramic insulating material to the magnetic powder to thus form an insulating coating layer on the surface of the magnetic powder is applied.

However, when an excessive amount of the insulating material is added in order to form the insulating coating layer, there is a problem in that magnetic properties are deteriorated due to the occurrence of agglomeration between powder and powder and between the insulating material and the insulating material and due to the low density of the molded body.

Details set forth as the background art are provided for the purpose of better understanding the background of the disclosure, and are not to be taken as an admission that the described details correspond to the conventional technology already known to those skilled in the art.

### SUMMARY

Accordingly, the present disclosure has been made keeping in mind the above problem occurring in the related art. An objective of the present disclosure is to provide a magnetic body for an inductor, which has an excellent direct-current bias property in a high-current region, and a method of manufacturing a magnetic material for an inductor including the same.

A magnetic body for an inductor according to an embodiment of the present disclosure is a magnetic body used in an inductor for high current. The magnetic body includes a core particle including an iron-aluminum-based (Fe—Al-based) alloy containing 10 wt % or more of Al and a balance of Fe and other inevitable impurities, and an insulating layer including aluminum oxide (Al₂O₃) formed on the surface of the core particle.

The Fe—Al-based alloy contains 13.0 to 14.0 wt % of Al.

The Fe—Al-based alloy is a powder of spherical particles having a diameter of 106 μm or less and an average grain size of 20 to 40 μm.

The insulating layer has a thickness of 0.5 to 1 μm.

The magnetic body has a direct-current bias property of 80% or more when a measured intensity of magnetization is 130 to 150 Oe.

In the magnetic body, a decrease rate of a direct-current bias property is 50% or less while a measured intensity of magnetization is increased from 0 Oe to 400 Oe.

Meanwhile, a method of manufacturing a magnetic material for an inductor according to an embodiment of the present disclosure is a method of manufacturing a magnetic material used in an inductor for high current. The method includes: a core-particle preparation step of preparing core particles containing 10 wt % or more of Al and a balance of Fe and other inevitable impurities; an insulating-material preparation step of preparing a main insulating material by removing moisture from talc (Mg₃Si₄O₁₀(OH)₂); a first mixing step of mixing the prepared core particles and the main insulating material to prepare a first mixture; and a first heat treatment step of heat-treating the prepared first mixture to 900 to 1300° C. A magnetic body is thus generated having an insulating layer including Al₂O₃ formed on the surface of the core particle.

In the core-particle preparation step, the core particles contain 13.0 to 14.0 wt % of Al.

The insulating-material preparation step includes roasting the talc (Mg₃Si₄O₁₀(OH)₂) at a temperature of 1000° C. or higher, thus generating the main insulating material having a moisture ratio of 1% or less.

The first mixing step includes mixing 0.1 to 10 parts by weight of the main insulating material based on 100 parts by weight of the core particles.

The first heat treatment step is performed at 900 to 1300° C. for 0.5 to 12 hours.

The first heat treatment step is performed in a mixed gas atmosphere of an inert gas and a reducing gas or in an inert gas atmosphere.

The method further includes a second mixing step of mixing the magnetic body with a lubricant to prepare a second mixture after the heat treatment step, a molding step of molding the prepared second mixture to generate a molded body, and a second heat treatment step of performing heat treatment to remove residual molding stress from the molded body.

The second mixing step includes mixing 0.1 to 5 parts by weight of the lubricant based on 100 parts by weight of core particles.

The second mixing step includes further mixing the second mixture with a sub-insulating material, which is a ceramic material different from a main insulating material.

The second heat treatment step includes heat-treating the molded body at 600 to 1000° C.

According to an embodiment of the present disclosure, it is possible to obtain a magnetic body for an inductor, which has an excellent direct-current bias property in a high-current region, by forming an insulating layer including Al₂O₃ in a uniform thickness on the surface of a core particle including an Fe—Al-based alloy using talc from which moisture is removed by roasting.

Further, the insulating layer is formed through high-temperature heat treatment using the talc from which moisture is removed. Accordingly, it is possible to suppress the occurrence of agglomeration between the core particles and between the insulating materials, and it is also possible to expect an effect of increasing the grain size of the core particles and removing internal stress.

In addition, conventionally, a two-step process of performing heat treatment of the core particles and then forming an insulating layer on the surface of the core particles is performed. According to the present disclosure, however, it is possible to form an insulating layer using a single-step process of heat-treating core particles and an insulating material at high temperatures. Therefore, an effect of simplifying the manufacturing process can be expected.

### BRIEF DESCRIPTION OF THE DRAWINGS

FIG. 1A is a graph showing a change in the maximum magnetic permeability (μm) of core particles depending on the content of Al;

FIG. 1B is a graph showing a change in hysteresis loss (Wh) of core particles depending on the content of Al;

FIG. 1C is a graph showing a change in coercive force (Hc) of core particles depending on the content of Al;

FIG. 1D is a graph showing a change in core loss (mW/cc) of core particles depending on the content of Al;

FIGS. 2A, 2B, and 2C are enlarged photographs showing the surfaces of the magnetic bodies according to Comparative Examples and Examples, and are views showing the results obtained by analyzing the surface components of the magnetic bodies; and

FIGS. 3 and 4 are graphs showing a percent change in a direct-current bias property due to high-temperature heat treatment of magnetic bodies according to the Comparative Examples and the Examples.

### DESCRIPTION OF THE EMBODIMENTS

Hereinafter, a detailed description is given of embodiments of the present disclosure with reference to the appended drawings. However, the present disclosure is not limited to the following embodiments and may be changed to have a variety of different forms. These embodiments are provided to complete the disclosure of the present disclosure and to fully describe the present disclosure to those skilled in the art.

A magnetic body for an inductor according to the present disclosure is a magnetic body used in an inductor for high current, and includes an insulating layer including Al₂O₃ formed on the surface of a core particle including a Fe—Al-based alloy.

The core particles form powder including the Fe—Al-based alloy, and contain 10 wt % or more of Al and a balance of Fe and other inevitable impurities. The content of Al may be 13.0 to 14.0 wt % in one example. The content of Al may be 13.0 to 13.6 wt % in another example.

The representative main factors of an inductor material include magnetic permeability, core loss, and a direct-current bias property. It can be expected that core loss is reduced by containing Al to increase a specific resistance value and that the magnetic permeability is increased by reducing a crystal magnetic anisotropy. Therefore, it may be advantageous to maintain the content of Al at 10% or more.

However, there are problems in that a yield strength is increased as the content of Al is increased and in that the maximum magnetic permeability is significantly reduced due to the regularization of the atomic arrangement at a specific content thereof. Therefore, it may be advantageous to limit the content of Al to 13.0 to 14.0 wt %.

The core particles form a powder of spherical particles having a diameter of 106 μm or less. In particular, the grain size of the core particles is increased during high-temperature heat treatment to form an insulating layer. Accordingly, it may be advantageous that the average grain size of the core particles be 20 to 40 μm.

In addition, the insulating layer is a layer that imparts an insulating property to the surface of the core particle, but in the present disclosure, the insulating layer serves to improve the direct-current bias property while imparting the insulating property.

This insulating layer is an oxide film including Al₂O₃ formed on the surface of the core particle through high-temperature heat treatment using a talc (Mg₃Si₄O₁₀(OH)₂) from which moisture is removed.

In one example, the insulating layer may be formed uniformly and strongly on the surface of the core particle.

Further, the thinner the insulating layer is, the better the properties thereof are. However, in order to maintain insulating and direct-current bias properties at desired levels, the insulating layer may be formed to a thickness of 0.5 to 1 μm.

As described above, in the magnetic body that includes the insulating layer including Al₂O₃ formed on the surface of the core particle including the Fe—Al-based alloy, a reduction in an inductance value (direct-current bias property) may be small in a high-current region (DC bias).

Therefore, in the magnetic body according to the present embodiment, it may be advantageous to maintain the direct-current bias property at 80% or more when the measured intensity of magnetization is 130 to 150 Oe.

Further, in the magnetic body, it may be advantageous to maintain the decrease rate of the direct-current bias property at 50% or less while the measured intensity of magnetization is increased from 0 Oe to 400 Oe.

Next, a method of manufacturing a magnetic material for an inductor using the magnetic body as disclosed above is described.

A method of manufacturing a magnetic material for an inductor according to an embodiment of the present disclosure is a method of manufacturing a magnetic material used in an inductor for high current. The method includes: a core-particle preparation step of preparing core particles including a Fe—Al-based alloy; an insulating-material preparation step of preparing a main insulating material by removing moisture from a talc (Mg₃Si₄O₁₀(OH)₂); a first mixing step of mixing the prepared core particles and the main insulating material to prepare a first mixture; and a first heat treatment step of heat-treating the prepared first mixture at 900 to 1300° C. A magnetic body is thus generated having an insulating layer including Al₂O₃ formed on the surface of the core particles.

In addition, the method further includes a second mixing step of mixing the magnetic body with a lubricant to prepare a second mixture after the heat treatment step, a molding step of molding the prepared second mixture to generate a molded body, and a second heat treatment step of performing heat treatment to remove residual molding stress from the molded body.

The core-particle preparation step is a step of preparing spherical core particles with the Fe—Al-based alloy. Molten steel is prepared so as to contain 10 wt % or more of Al and a balance of Fe and other inevitable impurities, and a spraying method is then used to manufacture a powder of spherical particles.

The content of Al in the core particles may be 13.0 to 14.0 wt % in one example. The content thereof may be 13.0 to 13.6 wt % in another example.

The insulating-material preparation step is a step of preparing a main insulating material used to form the insulating layer on the core particles. In the present embodiment, the talc (Mg₃Si₄O₁₀(OH)₂) from which moisture is removed is used as the main insulating material.

In general, talc typically contains 5 to 10 wt % of moisture. In the case of forming the insulating layer using normal talc from which moisture is not removed, there is a problem in that a core loss value is increased.

Therefore, in the present embodiment, talc from which moisture is removed is used as the main insulating material. In order to remove moisture from the talc, the talc is roasted at a temperature of 1000° C. or higher. Therefore, it may be advantageous to maintain the moisture content of the talc at a level of 0%. However, talc from which all moisture is completely removed may take on moisture when exposed to the atmosphere. Therefore, in the present embodiment, the moisture of the talc from which the moisture is removed (roasted talc) is limited to 1% or less, whereby the above-mentioned talc is distinguished from talc (normal talc) from which moisture is not removed.

The first mixing step is a step of mixing the prepared core particles and main insulating material to prepare the first mixture.

In one example, 0.1 to 10 parts by weight of the main insulating material is mixed based on 100 parts by weight of the core particles. In one example, 1 part by weight of the main insulating material is mixed based on 100 parts by weight of the core particles.

The talc (roasted talc), from which moisture is removed, as the main insulating material serves to prevent seizing when mixed with the core particles and also acts as an insulating agent.

Therefore, there is a problem in that magnetic permeability is reduced as the mixing amount of the main insulating agent is increased. Accordingly, it may be advantageous to limit the mixing amount of the main insulating agent to 0.1 to 10 parts by weight.

The first heat treatment step is a step of forming the insulating layer using the main insulating material on the surface of the core particle, thus generating a magnetic body. The prepared first mixture is heat-treated at a high temperature so that Al contained in the surface of the core particle reacts with oxygen (O) contained in the main insulating material to thus form the insulating layer including Al₂O₃, which is a uniform and strong oxide film, on the surface of the core particle.

The first heat treatment step is performed at 900 to 1300° C. for 0.5 to 12 hours. In one example, the heat treatment may be performed at 1100° C. for 2 to 3 hours.

In particular, the first heat treatment step may be performed in a mixed gas atmosphere of an inert gas and a reducing gas or in an inert gas atmosphere. For example, nitrogen (N₂) may be used as the inert gas, and hydrogen (H₂) may be used as the reducing gas. Meanwhile, the reason why the first heat treatment step is not performed in an atmosphere including only the reducing gas, i.e., only a hydrogen (H₂) gas, is because the insulating layer is not formed on the surface of the core particle when the heat treatment is performed in an atmosphere including only the hydrogen (H₂) gas.

As described above, the high-temperature heat treatment may be performed in the first heat treatment step, thus forming a uniform and strong insulating layer on the surface of the core particle. In particular, in order to maintain the desired level of insulating and direct-current bias properties, the insulating layer may be formed to a thickness of 0.5 to 1 μm.

In addition, during the first heat treatment step, the core particles increase in size as the grains thereof grow. Therefore, after the first heat treatment step, the core particles grow until the average grain size thereof becomes about 20 to 40 μm.

Further, during the first heat treatment step, the internal stress of the magnetic body is removed, thus improving magnetic properties.

The second mixing step is a step of dry-mixing the magnetic body, which is prepared in order to manufacture the magnetic material for the inductor, with a lubricant, thus generating a second mixture. A typical lubricant used in magnetic materials may be mixed with the prepared magnetic body. With respect to the content of the lubricant, 0.1 to 5 parts by weight of the lubricant may be mixed based on 100 parts by weight of the core particles.

Further, in the second mixing step, a sub-insulating material, which is a ceramic material different from the main insulating material, may be further mixed in order to improve an insulating property.

The molding step is a step of molding the second mixture into a desired shape in order to form the prepared magnetic material for the inductor, thereby generating the molded body. For example, the second mixture may be compression-molded under a high pressure of 8 tons/cm² or more.

The second heat treatment step is a heat treatment step of removing residual molding stress remaining during the molding of the molded body, and the molded body is heat-treated at 600 to 1000° C.

The second heat treatment step may be performed in a mixed gas atmosphere of an inert gas and a reducing gas or in an inert gas atmosphere for 0.5 to 12 hours.

Next, the present disclosure is described through Examples and Comparative Examples.

First, the reason for limiting the content range of Al in the core particles is described.

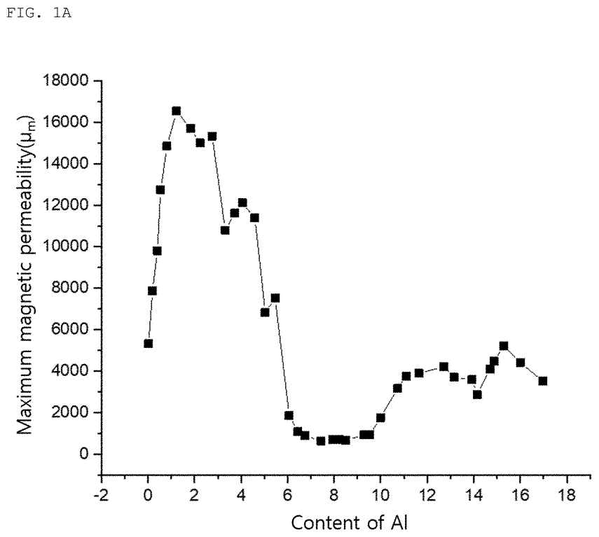

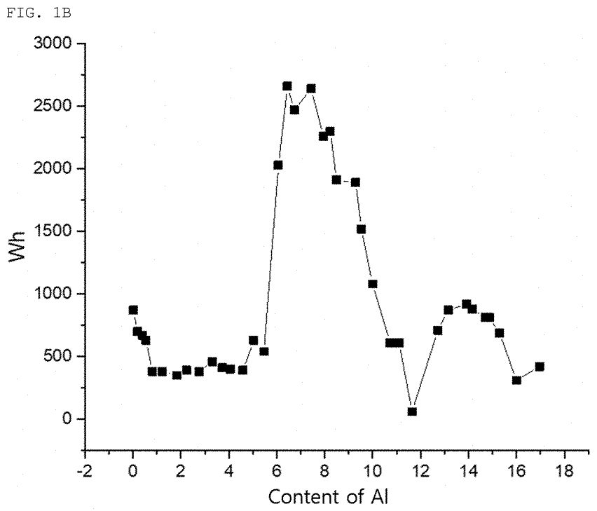

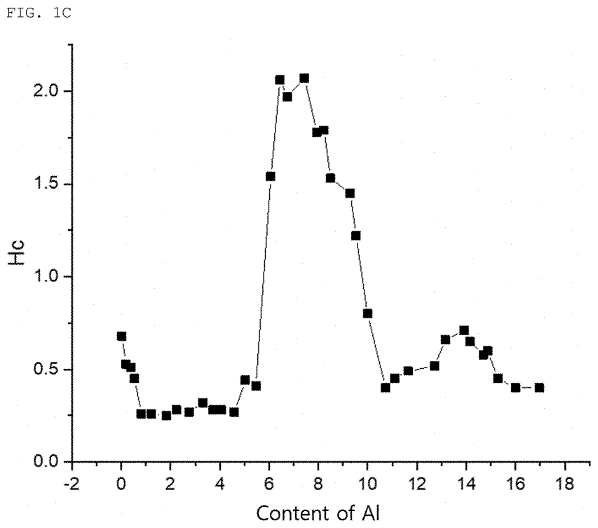

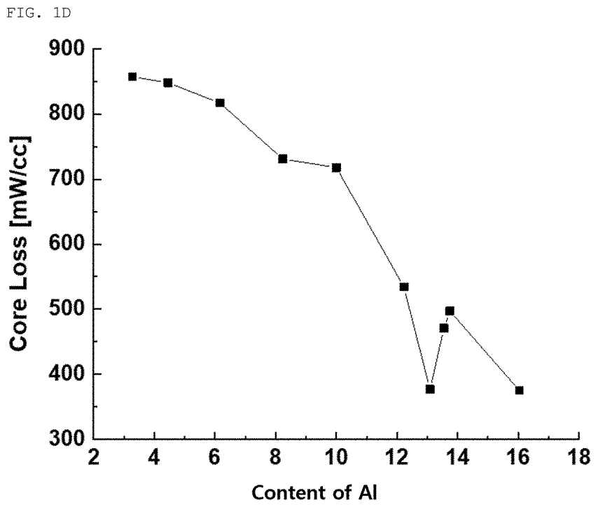

The maximum magnetic permeability, hysteresis loss, and coercive force were measured for the specimen manufactured by changing the content of Al contained in the core particles, and the results are shown in FIGS. 1A-1C.

FIG. 1A is a graph showing a change in the maximum magnetic permeability (μm) of the core particles depending on the content of Al. FIG. 1B is a graph showing a change in hysteresis loss (Wh) of the core particles depending on the content of Al. FIG. 1C is a graph showing a change in coercive force (Hc) of the core particles depending on the content of Al. FIG. 1D is a graph showing a change in core loss (mW/cc) of the core particles depending on the content of Al.

As can be seen from FIG. 1A, it can be confirmed that the maximum magnetic permeability is increased as Al is contained in a content of 10 wt % or more.

In addition, as can be seen from FIGS. 1B and 1C, it can be confirmed that the hysteresis loss and the coercive force start to be reduced when the content of Al is 8 wt % or more, and remain low when the content thereof is in the range of 10 wt % or more.

Further, as can be seen from FIG. 1D, it can be confirmed that the core loss begins to rapidly drop as the content of Al is 10 wt % or more, and has the lowest value in the content range of 13.0 to 14.0 wt %, and preferably 13.0 to 13.6 wt %.

Therefore, it can be confirmed that it is useful to maintain the content of Al in the Fe—Al-based alloy forming the magnetic body at 10 wt % or more, preferably at 13.0 to 14.0 wt %, and more preferably at 13.0 to 13.6 wt %.

Next, the utility of high-temperature heat treatment and the reason for limiting the temperature is described.

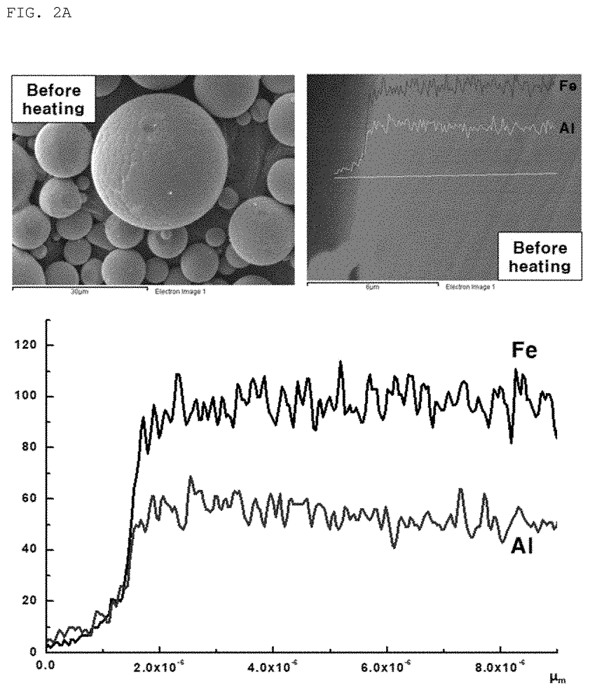

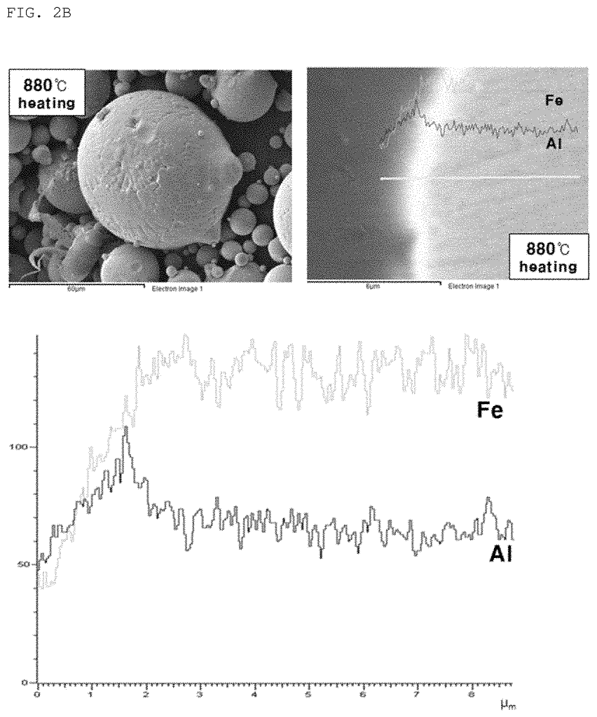

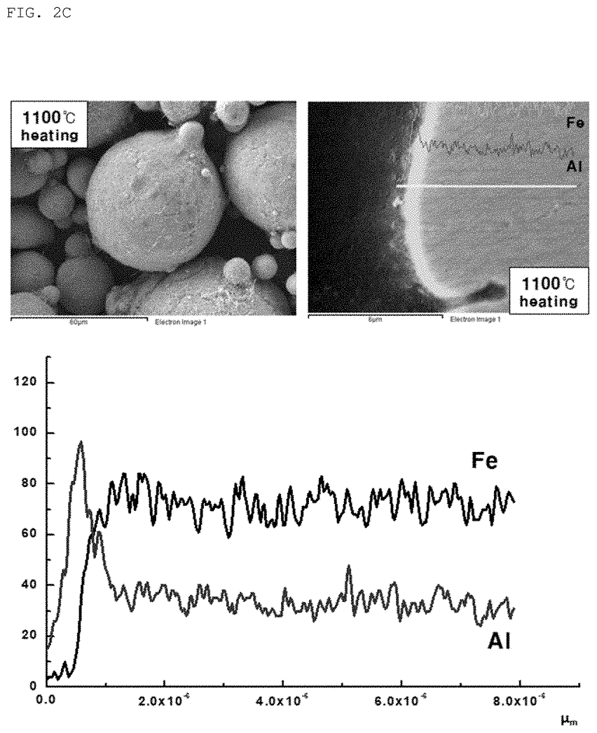

After a mixture of 99 wt % of core particles and 1 wt % of talc (roasted talc) from which moisture was removed was obtained, the surfaces of the magnetic bodies before high-temperature heat treatment, the magnetic body heat-treated at 880° C. for 2 hours, and the magnetic body heat-treated at 1100° C. for 2 hours were observed, and the surface components thereof were analyzed. The results are shown in FIGS. 2A-2C.

FIGS. 2A-2C are enlarged photographs showing the surfaces of the magnetic bodies, and are views showing the results obtained by analyzing the surface components of the magnetic bodies.

FIG. 2A is a view showing a magnetic body before heat treatment, FIG. 2B is a view showing a magnetic body that has been heat-treated at 880° C., and FIG. 2C is a view showing a magnetic body that has been heat-treated at 1100° C.

As can be seen from FIG. 2A, it can be confirmed that the insulating layer is not yet formed on the surface of the magnetic body before the high-temperature heat treatment.

In addition, as can be seen from FIG. 2B, it can be confirmed that in the magnetic body that is heat-treated at 880° C., the grain size of the core particles is increased and the insulating layer is insufficiently formed, even though the insulating layer is observed.

In contrast, as can be seen from FIG. 2C, it can be confirmed that the insulating layer is formed on the surface of the magnetic body heat-treated at 1100° C. In particular, it can be confirmed that a uniform and strong insulating layer (Al₂O₃) having a thickness of about 0.5 to 1 μm is formed on the surface of the core particle, and that the content of Al is higher than the content of Fe in the range in which the insulating layer is formed.

Accordingly, it can be confirmed that a desired insulating layer is formed when the heat treatment is performed in the range of 900 to 1300° C. during the first heat treatment step.

Next, a change in a direct-current bias property according to the high-temperature heat treatment is described.

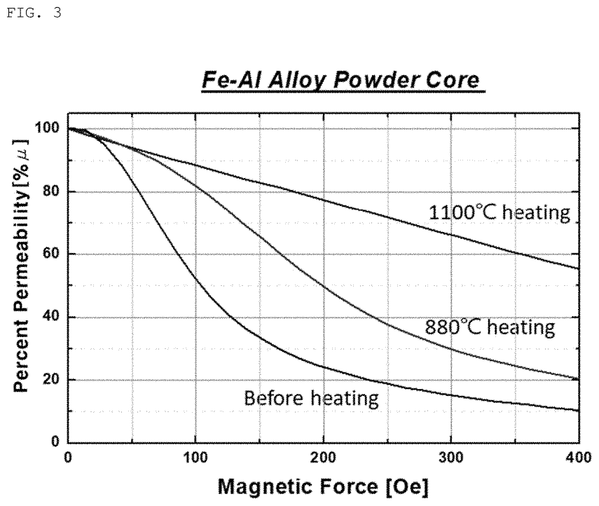

After 99 wt % of the core particles and 1 wt % of the talc (roasted talc) from which moisture was removed were mixed, changes in a direct-current bias property (percent permeability) were measured while the intensities of magnetization (magnetic force) of the magnetic body (Comparative Example 1) before high-temperature heat treatment, the magnetic body (Comparative Example 2) heat-treated at 880° C. for 2 hours, and the magnetic body (Example 1) heat-treated at 1100° C. for 2 hours were increased. The results are shown in FIG. 3 and Table 1.

In Table 1, the decrease rate means the decrease rate (%) of the direct-current bias property measured at 400 Oe with respect to the intensity of magnetization of 0 Oe.

TABLE 1

| | | Intensity of | | | | | | | | Decrease |
|---|---|---|---|---|---|---|---|---|---|---|
| | | magnetization (Oe) | | | | | | | | ratio |
| | | 0 | 80 | 100 | 130 | 150 | 165 | 200 | 400 | (%) |
| Direct- | Comparative | 53.6 | 61.6 | 53.6 | 36.3 | 32.9 | 29.8 | 23.2 | 10.4 | 80.6 |
| current | Example 1 | | | | | | | | | |
| bias | Comparative | 82.8 | 86.5 | 82.8 | 69.2 | 64.9 | 60.1 | 47.5 | 20.4 | 75.3 |
| property | Example 2 | | | | | | | | | |
| (%) | Example 1 | 88.7 | 90.3 | 88.7 | 84.1 | 82.7 | 81.2 | 76.6 | 55.1 | 37.9 |

As can be seen from FIG. 3 and Table 1, it can be confirmed that the direct-current bias property of Example 1, which is the magnetic body heat-treated at 1100° C. according to the present disclosure, is the best in all ranges of the measured intensities of magnetization.

In particular, in Example 1, it can be confirmed that the direct-current bias property is maintained at 80% or less, namely 84.1 to 88.7%, when the measured intensity of magnetization is 130 to 150 Oe, corresponding to the range of intensity of magnetization applied to recent high-current inductors.

In contrast, when the measured intensity of magnetization is in the range of 130 to 150 Oe, the direct-current bias property is maintained at 36.3 to 53.6% in Comparative Example 1 and at 64.9 to 69.2% in Comparative Example 2.

In particular, in Example 1, while the measured intensity of magnetization is increased from 0 Oe to 400 Oe, the decrease rate of the direct-current bias property is maintained at 50% or less, specifically 37.9%. However, the decrease rate is 80.6% in Comparative Example 1 and 75.3% in Comparative Example 2.

From this result, it can be confirmed that the direct-current bias property is improved when heat treatment is performed at a high temperature according to Example 1 of the present disclosure.

Next, the change in direct-current bias property depending on whether or not the core particles are mixed with the talc (roasted talc) from which moisture is removed is described.

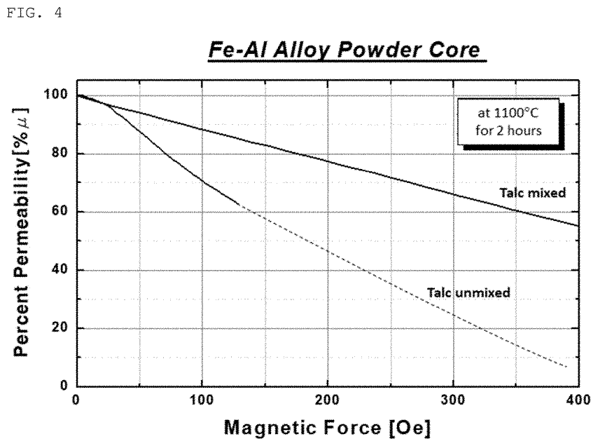

Core particles (Comparative Example 3) that were not mixed with the talc (roasted talc) from which moisture was removed were prepared, and core particles (Example 2) that were mixed with 1 wt % of the talc (roasted talc) from which moisture was removed were also prepared. In addition, the prepared core particles according to Comparative Example 3 and Example 2 were heat-treated at 1100° C. for 2 hours, and the change in a direct-current bias property (percent permeability) was then measured while the intensity of magnetization (magnetic force) was increased. The results are shown in FIG. 4

As can be seen from FIG. 4, it can be confirmed that the direct-current bias property is significantly lower in Comparative Example 3 than in Example 2 in all regions of the measured intensity of magnetization.

This result may imply that in the case of Comparative Example 3, since there is no mixing with the talc (roasted talc) from which moisture is removed, seizing occurs between the core particles during the heat treatment, which reduces an insulating property.

Next, magnetic properties were compared based on whether or not moisture was removed from the talc.

After 1 wt % of the talc (normal talc) from which moisture was not removed and 99 wt % of the core particles were mixed, the magnetic body (Comparative Example 4) heat-treated at 1100° C. for 2 hours was prepared. Further, after 1 wt % of the talc (roasted talc) from which moisture was removed and 99 wt % of the core particles were mixed, the magnetic body (Example 3) heat-treated at 1100° C. for 2 hours was prepared. Thereafter, magnetic properties such as magnetic permeability, a direct-current bias property (percent permeability), and core loss were measured, and the results are shown in Table 2.

TABLE 2

| | Magnetic properties | | | | | |
|---|---|---|---|---|---|---|
| | Magnetic | Intensity of | | Core Loss (50 | | |
| | permeability | magnetization | | kHz/0.1 T) | | |
| Classification | (100 kHz) | 50 Oe | 100 Oe | Pcv | Pev | Phv |
| Comparative | 62 | 86 | 63 | 597 | 53 | 38 |
| Example 4 | | | | | | |
| Example 3 | 47 | 93 | 80 | 391 | 16 | 376 |

As can be seen from Table 2, it can be confirmed that the all magnetic properties are superior in Example 3 compared to the Comparative Example 4.

Although the embodiments of the present disclosure have been disclosed for illustrative purposes, those having ordinary skill in the art should appreciate that various modifications, additions and substitutions are possible, without departing from the scope and spirit of the disclosure as disclosed in the accompanying claims.

What is claimed is:

1. A magnetic body for an inductor, which is used in the inductor for a high current, the magnetic body comprising:
a core particle including a Fe—Al-based alloy containing 10 wt % or more of Al and a balance of Fe and other inevitable impurities; and
an insulating layer including Al₂O₃ formed on a surface of the core particle.

2. The magnetic body of claim 1, wherein the Fe—Al-based alloy contains 13.0 to 14.0 wt % of Al.

3. The magnetic body of claim 1, wherein the Fe—Al-based alloy is a powder of spherical particles having a diameter of 106 μm or less and an average grain size of 20 to 40 μm.

4. The magnetic body of claim 1, wherein the insulating layer has a thickness of 0.5 to 1 μm.

5. The magnetic body of claim 1, wherein the magnetic body has a direct-current bias property of 80% or more when a measured intensity of magnetization is 130 to 150 Oe.

6. The magnetic body of claim 1, wherein, in the magnetic body, a decrease rate of a direct-current bias property is 50% or less while a measured intensity of magnetization is increased from 0 Oe to 400 Oe.

7. A method of manufacturing a magnetic material for an inductor, which is used in an inductor for high current, the method comprising:
a core-particle preparation step of preparing core particles containing 10 wt % or more of Al and a balance of Fe and other inevitable impurities;
an insulating-material preparation step of preparing a main insulating material by removing moisture from a talc (Mg₃Si₄O₁₀(OH)₂);
a first mixing step of mixing the prepared core particles and the main insulating material to prepare a first mixture; and
a first heat treatment step of heat-treating the prepared first mixture at 900 to 1300° C., thus generating a magnetic body having an insulating layer including Al₂O₃ formed on a surface of the core particle.

8. The method of claim 7, wherein, in the core-particle preparation step, the core particles contain 13.0 to 14.0 wt % of Al.

9. The method of claim 7, wherein the insulating-material preparation step includes roasting the talc (Mg₃Si₄O₁₀(OH)₂) at a temperature of 1000° C. or higher, thus generating the main insulating material having a moisture ratio of 1% or less.

10. The method of claim 7, wherein the first mixing step includes mixing 0.1 to 10 parts by weight of the main insulating material based on 100 parts by weight of the core particles.

11. The method of claim 7, wherein the first heat treatment step is performed at 900 to 1300° C. for 0.5 to 12 hours.

12. The method of claim 11, wherein the first heat treatment step is performed in a mixed gas atmosphere of an inert gas and a reducing gas, or in an inert gas atmosphere.

13. The method of claim 7, further comprising:
a second mixing step of mixing the magnetic body with a lubricant to prepare a second mixture after the heat treatment step;
a molding step of molding the prepared second mixture to generate a molded body; and
a second heat treatment step of performing heat treatment to remove residual molding stress from the molded body.

14. The method of claim 13, wherein the second mixing step includes mixing 0.1 to 5 parts by weight of the lubricant based on 100 parts by weight of core particles.

15. The method of claim 13, wherein the second mixing step includes further mixing the second mixture with a sub-insulating material, which is a ceramic material different from a main insulating material.

16. The method of claim 13, wherein the second heat treatment step includes heat-treating the molded body at 600 to 1000° C.
